(19) United States
(12) Patent Application Publication
(10) Pub. No.: US 2017/0311575 A1
(43) Pub. Date: Nov. 2, 2017

(54) BIRD FEEDER WITH DETACHABLE DECORATIVE AND CAMOUFLAGE FEATURES

(71) Applicant: Ntxhuav Kong, Nixa, MO (US)

(72) Inventor: Ntxhuav Kong, Nixa, MO (US)

(21) Appl. No.: 15/140,855

(22) Filed: Apr. 28, 2016

(51) Int. Cl. A01K 39/01; A01K 45/00; A01K 39/04; B44F 9/00; A01K 39/02

(52) U.S. Cl. CPC A01K 39/01; B44F 9/00; A01K 39/0206; A01K 39/04; A01K 45/00

(57) ABSTRACT

A bird feeder with detachable decorative and camouflage features is disclosed. The bird feeder includes a base supporting a housing configured to contain bird feed. In one embodiment, the base includes feeding posts having an annular groove for receiving a synthetic flower and elastic ring to provide a detachable decorative feature. In other embodiments, the bird feeder includes a foliage support having a plurality of foliage receptacles. The foliage receptacles have a serrated inner surface for receiving and retaining the stem of detachable foliage.

### FIELD

The present invention relates generally to bird feeders. More specifically, the invention relates to a bird feeder with detachable decorative and camouflage features which impart an appearance of a bird's natural feeding environment.

### BACKGROUND

Various types of bird feeders exist in the prior art. For example, ground feeders, nectar feeders, hopper feeders, suet feeders, tube feeders and platform feeders are known with each have varying configurations that are generally used with different types of bird feed. The configuration of the feeder and the feed used generally determine the type of bird the feeder will attract.

Some bird feeders are most suitable to attract only one type of bird, such as nectar feeders for hummingbirds, while other feeders attract a wide variety of birds, such as platform feeders that are commonly used to attract jays, cardinals and sparrows.

Regardless of the configuration, bird feeders are all used for a similar purpose, to attract birds into an area they may not otherwise go. For example, feeders are often located in residential backyards for the purposes of birdwatching, with some types of feeders used to attract birds for hunting and trapping.

In order to entice birds to leave their natural habitat and approach a manmade structure such as a bird feeder, the feeder must appear nonthreatening and natural. To achieve that nonthreatening and natural appearance, some feeders include elements that attempt to mimic objects found in a bird's natural habitat. For example, some feeders include leaf or flower shapes, either painted on the feeder or formed as a separate part affixed to the feeder. Hummingbird feeders commonly have plastic flower shapes surrounding their feeding posts. For example, U.S. Pat. No. 5,450,816 discloses a free-standing hummingbird feeder having an artificial flower surrounding a feeding port and U.S. Pat. No. 8,763,556 teaches feeding ports on a hummingbird feeder which are surrounded by flexible synthetic flowers.

However, the feeders described in U.S. Pat. Nos. 5,450,816 and 8,763,556, as well as feeders currently for sale on the market, do not have the capability for a user to customize the feeder's camouflage and decorative elements to suit the environment in which the feeders are used. Further, the prior art does not disclose a bird feeder in which decorative and camouflage features can be moved between different feeders. Known bird feeders typically include non-movable or non-transferrable camouflage and decorative elements, usually in the form of painted images or permanently affixed parts that do not impart a realistic environmental appearance to the feeder.

Thus, there remains a need in the art for a bird feeder or system for use with a bird feeder that allows for the detachment, rearrangement, and re-use of realistic decorative and camouflage features.

### SUMMARY

The present invention is directed to a bird feeder with detachable decorative and camouflage features that can be re-used, rearranged, or moved between feeders. In an exemplary embodiment, the bird feeder includes a base having a feeder pedestal, with a housing attached to and extending upwardly from the base. A hanger affixed to the top of the housing allows the bird feeder to be attached to a brace, pole, chain, or other support apparatus to place the feeder in a desired position. Alternatively, the feeder can be freestanding, with the base of the feeder resting on a platform, table, or other surface.

In one exemplary embodiment in which the bird feeder is a hummingbird feeder, the housing comprises a container operable to hold a quantity of nectar or other liquid feed, with the base including a series of protruding feeding posts arranged along the upper surface of the base, each post in fluid communication with the container such that the nectar is dispersed to the feeding posts. An annular V-shaped groove adjacent the tip of each post is configured to receive and secure a camouflage or decorative synthetic flower and an elastic ring such that, with the flower place around the post and the elastic ring securing it in place, the feeding post is disguised with only the center portion accessible through the center of the flower. In alternative embodiments feeding posts or faux feeding posts are positioned on the housing to allow placement of additional decorative or camouflage elements.

A ring shaped foliage support mounted on the housing near the top of the housing includes a plurality of generally cylindrical foliage receptacles arranged in a radial pattern, each receptacle having a serrated interior surface configured to grip the outer surface of an inserted stem or branch. With stems of organic or synthetic foliage and/or leaves inserted into the foliage receptacles and draped down around the housing, the bird feeder takes on a more natural appearance as the veil of supported foliage disguises the housing.

In other embodiments the base of the bird feeder comprises a feeding tray for holding solid or granular feed, and includes faux feeding posts for securing synthetic flowers with an elastic ring. In further embodiments, foliage supports or foliage receptacles are positioned around the upper portion of the housing. In other embodiments, foliage supports or foliage receptacles are placed or formed at various locations along the base and housing so that organic or synthetic foliage can be placed and secured at those locations.

### BRIEF DESCRIPTION OF THE DRAWINGS

FIG. 1 is a perspective view of a hummingbird feeder with detachable decorative and camouflage features in accordance with a first exemplary embodiment of the present invention.

FIG. 2 is an exploded view of the bird feeder with detachable decorative and camouflage features of FIG. 1.

FIG. 3 is a cross sectional view of the bird feeder with detachable decorative and camouflage features of FIG. 1.

FIG. 4 is a close-up view of a feeding post and camouflage flower portion of the bird feeder with detachable decorative and camouflage features of FIG. 1.

FIG. 5 is a side view of the feeding post and camouflage flower portion of the bird feeder with detachable decorative and camouflage features of FIG. 4.

FIG. 6 is a close-up view of a holder portion of the bird feeder with detachable decorative and camouflage features of FIG. 1.

FIG. 7 is a close-up bottom view of a portion of the bird feeder with detachable decorative and camouflage features of FIG. 1.

FIG. 8 is a perspective view of a bird feeder with detachable decorative and camouflage features in accordance with a second exemplary embodiment of the present invention.

FIG. 9 is a perspective view of a bird feeder with detachable decorative and camouflage features in accordance with a third exemplary embodiment of the present invention.

FIG. 10 is a perspective view of a bird feeder with detachable decorative and camouflage features in accordance with a fifth exemplary embodiment of the present invention.

FIG. 11 is a perspective view of a bird feeder with detachable decorative and camouflage features in accordance with a sixth exemplary embodiment of the present invention.

FIG. 12 is a perspective view of a bird feeder with detachable decorative and camouflage features in accordance with a seventh exemplary embodiment of the present invention.

FIG. 13 is a perspective view of a bird feeder with detachable decorative and camouflage features in accordance with an eighth exemplary embodiment of the present invention.

### DETAILED DESCRIPTION OF EXEMPLARY EMBODIMENTS

Various embodiments of the present invention are disclosed herein, it is to be understood that the disclosed embodiments are merely exemplary of the invention, which may be embodied in various forms. Thus, any specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

Certain terminology used in the following description is for convenience in reference only and is not limiting. For example, the words “vertically,” “horizontally,” “vertical,” “horizontal” and “upwardly,” “downwardly,” “upper,” “lower” all refer to the depicted position of the element or embodiment to which the reference is made. The words “inwardly” and “outwardly” refer to directions toward and away from, respectively, the geometric center of the embodiment being designated and parts thereof. The terminology used herein may include the words specifically mentioned, derivatives thereof and words of a similar import. It is further understood that terminology such as the aforementioned directional phrases may be used to describe exemplary embodiments of the bird feeder with detachable decorative and camouflage features as shown in the figures herein with a housing portion positioned vertically above a base portion. This is for convenience only as it is understood that the exemplary embodiments of the feeder and system described may also be used in other than vertical orientation.

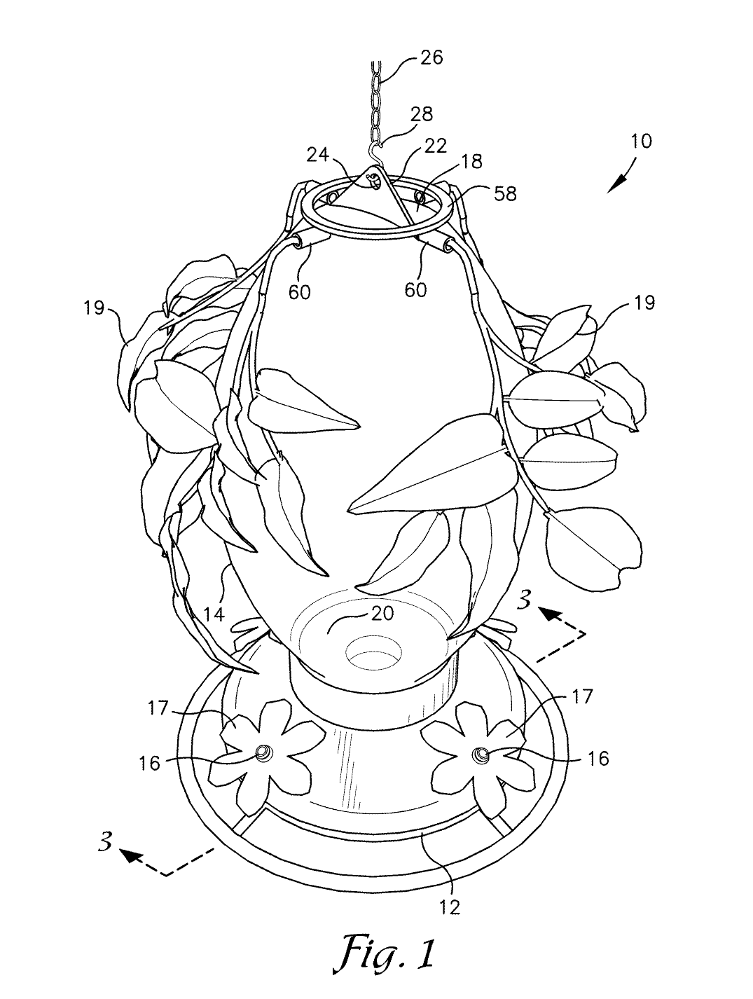

Looking first to FIG. 1, a bird feeder with detachable decorative and camouflage features in accordance with an exemplary embodiment of the present invention is depicted generally by the numeral 10. The bird feeder 10 includes a base 12 extending across the lower end of the feeder with a housing 14 attached to and extending upwardly from the base. In the exemplary embodiment depicted, housing 14 comprises a tank having an inner cavity configured to contain a quantity of nectar or other liquid hummingbird feed, with the base 12 comprising a plurality of feeding posts 16 in fluid communication with the inner cavity of the tank so as to convey liquid feed from the tank to the posts for consumption by the hummingbirds. The feeding posts 16 and portions of the base 12 are camouflaged by detachable synthetic flowers 17 which are positioned and attached at the upper end of the feeding post. The flowers 17 are typically pliable and made from a synthetic material such as polyester or plastic. It is foreseen that flower 17 may also be rigid in certain situations. Portions of the housing 14 are camouflaged by synthetic or organic foliage 19 attached at the upper portion of the housing and draped in a camouflage veil down and around the housing. It should be understood that while the bird feeder of FIG. 1 is configured as a hummingbird feeder, the present invention anticipates and encompasses other types of feeders as will be described with respect to other exemplary embodiments described herein below.

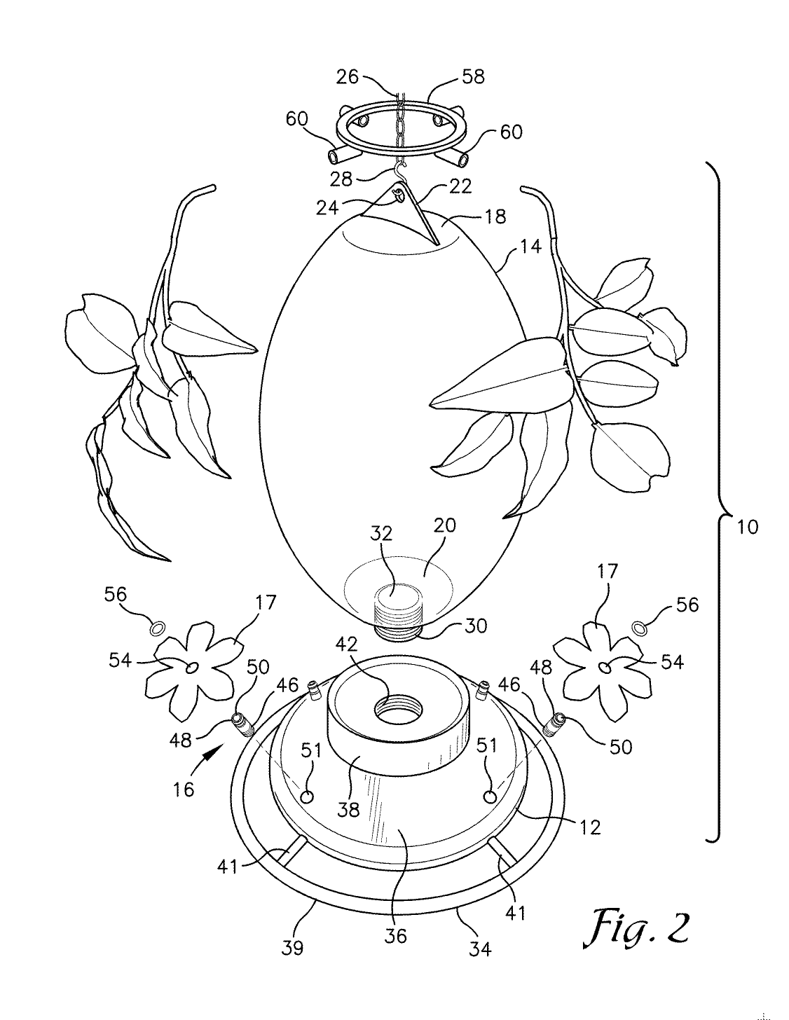

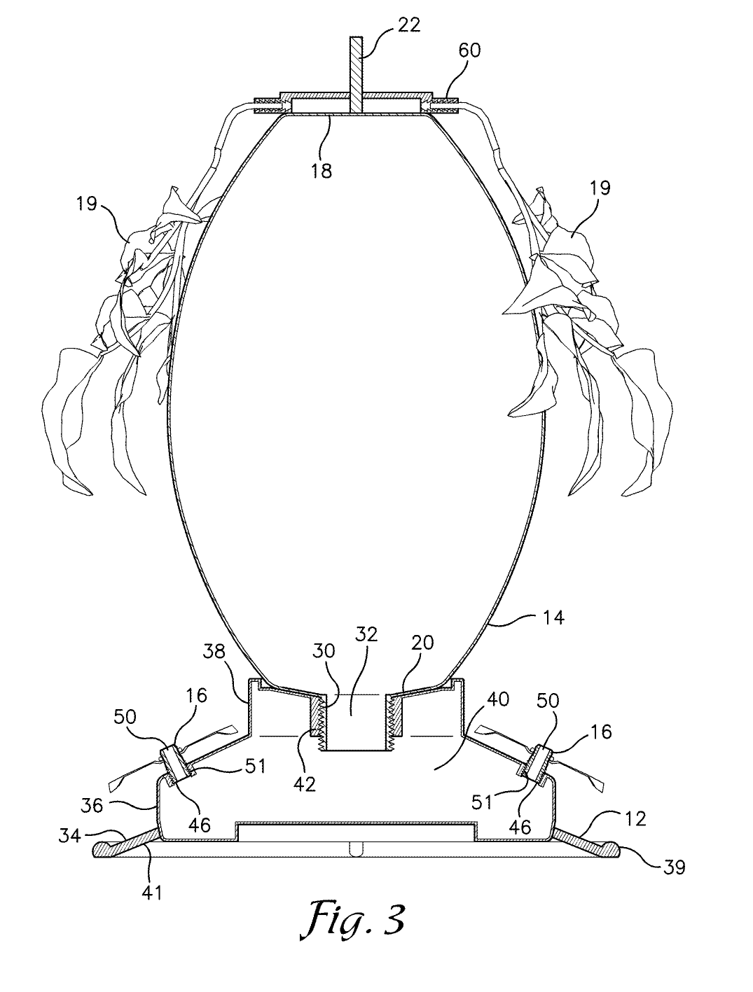

As seen in FIGS. 2 and 3, exploded and cross-sectional views of the hummingbird feeder of FIG. 1, housing 14 is an elongated, generally oval-shaped globe having flattened, circular shaped upper 18 and lower 20 ends.

Upper end 18 is solid, enclosing the entire upper end of the housing 14. An inverted V-shaped tab 22 extends upwardly from the outer surface of upper end 18 to provide a surface for grasping or holding the housing. An aperture 24 formed through the upper portion of the tab 22 allows the housing 14, and thus the entire feeder, to be hung or suspended using a chain 26 and S-hook 28 as shown, or using a rope or any other suspension apparatus known in the art.

A cylindrical threaded nipple 30 extends downwardly from the bottom surface of lower end 20, the nipple includes a center passageway 32 in fluid communication with the inner cavity of the tank formed by housing 14 to allow nectar or liquid feed to flow from the tank and into the base 12 of the feeder. The housing 14 tank is preferably formed from a transparent, lightweight and strong rigid material, such as a plastic or glass. The housing 14 and upper 18 and lower 20 ends are preferably molded as an integral unit. Tab 22 may be formed integrally with the upper end piece 18, or may formed separately and attached to the end piece by gluing, welding, or other methods known in the art. Similarly, nipple 30 is preferably formed integrally with the lower end piece 20, or may be formed separately and attached to the end piece by gluing, welding, or other methods known in the art.

Looking still to FIGS. 2 and 3, base 12 is a generally circular shaped, stepped tower, with a larger diameter lower tier 34 forming the bottom surface of the base, a medium diameter middle tier 36 forming the body of the base, and a smaller diameter upper tier 38 formed as a generally cylindrical boss extending upwardly from the base. Lower tier 34 comprises an annular perch 39 supported by extensions 41 extending between perch 39 and middle tier 36. As best seen in the cross-sectional view of FIG. 3, the middle 36 and upper 38 tiers are hollow, defining a contiguous interior cavity 40. A threaded receptacle 42 formed in the center of the upper tier 38 defines a passageway 44 in fluid communication with the interior cavity 40. Base 12 is typically constructed of molded plastic, but it is foreseen that the base could also be made of wood, glass or ceramic.

As seen in FIGS. 2 and 3, the housing 14 tank is attached to the base 12 by screwing the threaded nipple 30 of the housing 14 into the corresponding threaded receptacle 42 of the base. With the housing tank and base thus attached, the inner cavity of the housing tank 14 is in fluid communication with the interior cavity 40 of the base, with nectar or liquid feed in the housing tank thus able to flow into the base through the passageway 32 in the threaded nipple 30.

Looking to FIGS. 2, 6, and 7, each feeding post 16 comprises a cylindrical tubular body having a passageway 50 extending axially though the length of the post, with a corresponding opening at the upper and lower ends of the post. Each feeding post 16 further comprises a threaded lower end 46 and a V-shaped annular groove 47 extending around the circumference of the post near the upper end 48. A series of threaded apertures 51 are formed through the wall of the base 12, in the middle tier 36 portion. With the threaded lower end 46 of the feeding posts 16 engaged in the corresponding threaded aperture 51 in the base, the exposed passageway 50 at the upper end of the post is in fluid communication with the interior cavity 40 of the base 12. It is also foreseen that feeding posts 16 may also be formed integrally with the base 12, or formed separately and attached to the base by gluing, welding, or other methods known in the art.

With the hummingbird feeder assembled as depicted in FIGS. 1 and 3, nectar or liquid feed from the housing tank can flow into the base as described above, and to the feeding ports 16 for consumption by the hummingbirds. As is known in the art, the partial vacuum created in the housing tank by inverting the filled tank into the base and the surface tension of the liquid feed or nectar prevents the feed from leaving the feeding ports until consumed by the birds.

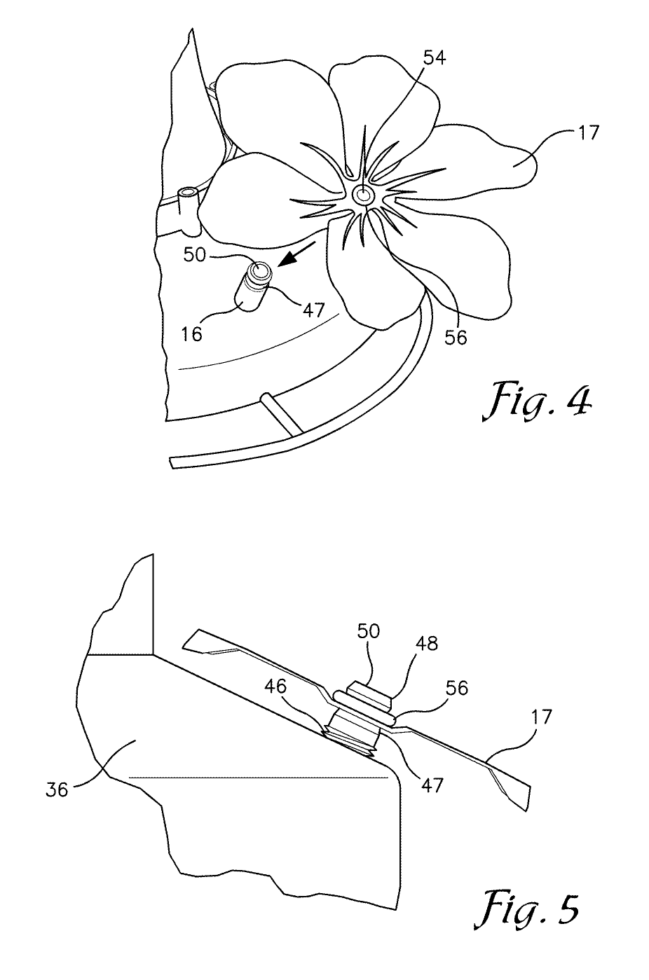

With the feeding posts 16 in place on the base, the upper end 48 of and V-shaped annular groove 47 of each post is exposed for attaching decorative or camouflage features as will now be described. As seen in FIG. 2 and as shown in more detail in FIGS. 4 and 5, the synthetic flower 17 includes a mounting aperture 54 through its center. The diameter of the mounting aperture preferably conforms approximately to the diameter of the V-shaped annular groove in the upper end of the post so that the synthetic flower can be stretched over and onto the upper end of the feeding post and positioned into the annular groove, as best seen in the close-up view of FIG. 5.

Looking to FIGS. 2 and 5, an elastic ring 56 is similarly stretched over and onto the upper end 48 of the feeding post 16 and positioned into the annular groove 47, atop the synthetic flower 17 previously positioned so that, as best seen in FIG. 5, with the flower positioned onto the post and seated in the annular groove at the upper end of the post, the elastic ring is similarly positioned and seated so that the elastic ring secures the synthetic flower onto the post. Elastic ring 56 may be separate from flower 17 (as shown in FIG. 2) or attached to the flower 17 (as shown in FIG. 4). If elastic ring 56 is attached to flower 17, various methods of attachment may be used including gluing, sewing, chemical welding, or integrally forming it with the flower, or any other attachment methods known in the industry. It is understood that elastic ring 56 may take many forms including a stretchable ring or a band of elastic formed into an annular shape.

With the synthetic flower secured to the feeding post as just described, the center passageway 50 of the feeding post 16 is accessible in the center of the flower 17, with the remainder of the feeding post and a portion of the base 12 hidden behind the flower. The appearance of the flower serves to attract birds that are naturally attracted to the type of flower the synthetic flower resembles, the detachable flower further serves to disguise the base of the feeder.

It should be understood that the placement and arrangement of the feeding posts can vary from that depicted in the exemplary embodiment described and depicted, and that the arrangement and design of the synthetic flower may vary from that depicted without departing from the scope of the present invention. For example, the base may include more or fewer feeding posts than depicted, with more posts providing more decoration and/or camouflage and correspondingly more feeding points.

It should be further understood that the base may include faux feeding posts that are configured to hold a synthetic flower without providing a feeding point. For instance, solid posts having a similar configuration to the posts previously described but lacking a passageway to allow the flow of nectar or liquid feed may be used to provide mounting points for synthetic flowers without providing additional feeding points. Similarly, the base 12 may be manufactured with threaded receptacles that do not include a passageway into the interior cavity of the base so that mounting posts may be added to provide attachment points for additional synthetic flowers without providing additional feeding points.

Furthermore, with the configuration of the feeding posts and synthetic flower and elastic ring mounting arrangement set forth, it should be understood that similar feeding posts or faux feeding posts may be included on the housing portion of the feeder to allow decoration and camouflage of the housing. By reversing the described steps of placing synthetic flowers onto the posts, the elastic rings and synthetic flowers may likewise be easily detached from the feeding posts so that they can be used in other positions on the feeder, or moved to an entirely different feeder.

Looking back to FIGS. 1 and 2, the bird feeder 10 includes a ring-shaped foliage support 58 positioned above, and resting on, the upper end 18 of the housing tank 14. Four cylindrical foliage receptacles 60 are evenly spaced around the outer perimeter of the ring, with an open end of the receptacle oriented to face outwardly from the center of the ring. As seen in FIG. 3, the interior surface of each cylindrical foliage receptacle is serrated, having a series of concentric annular barbs extending from the interior wall of the receptacle towards the center axis, defining an axial opening through the center. The axial opening allows a stem or branch of an organic or decorative foliage piece to be inserted into the foliage receptacle 60. The serrated barbs on the interior surface of the receptacle grip the outer surface of the stem or branch, securing it into place. Thus, as depicted in FIG. 1, pieces of synthetic or organic foliage 19 are secured in the foliage support 58 and is arranged to cover the housing tank 14, with the foliage pieces draped downwardly from the foliage support 58 to cover the housing.

The foliage support 58 is preferably made from a rigid or semi-rigid material, such as plastic. Most preferably, the serrated barbs within the foliage receptacles are preferably flexible or resilient such that they flex slightly to conform to the outer diameter of an inserted branch or stem.

Similar to the detachable synthetic flowers previously described, the synthetic or organic foliage is detachable from the foliage receptacles 60 so that the foliage can be removed changed, rearranged, or re-used in other locations or on other bird feeders.

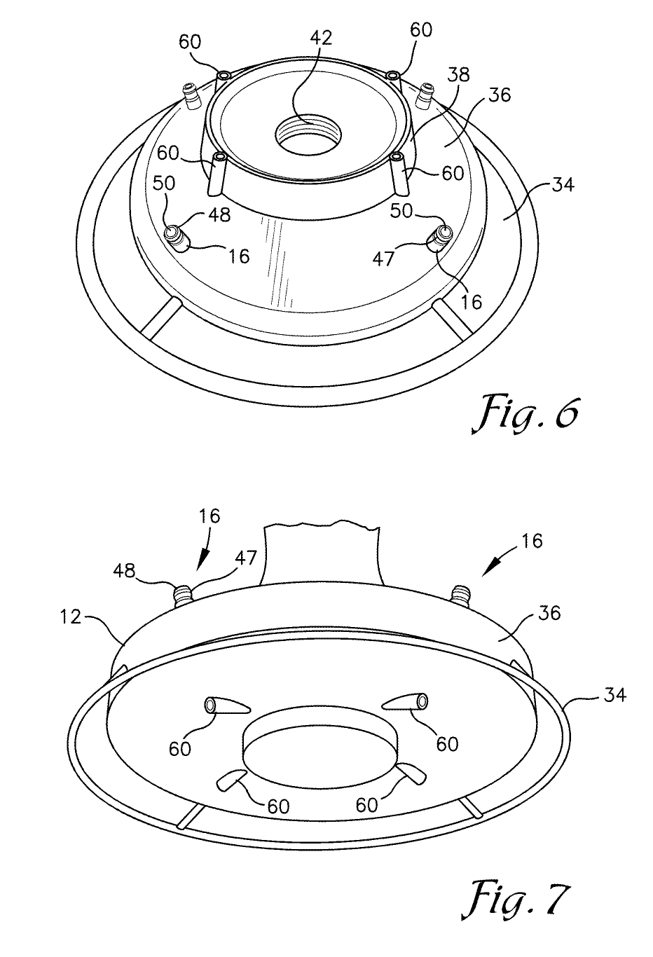

It should be understood that the configuration of the foliage support 58 and the placement of foliage receptacles 60 can vary without deviating from the scope of the present invention. For example, a foliage support comprising a plurality of foliage receptacles may be arranged as a straight bar for placement along a straight edge of a feeder. Or, individual foliage receptacles 60 may be located adjacent to or formed as part of the base or housing as shown in FIGS. 6 and 7. FIG. 7 shows foliage receptacles 60 located on the underside of base 12, and FIG. 6 shows foliage receptacles 60 located proximate upper tier 38.

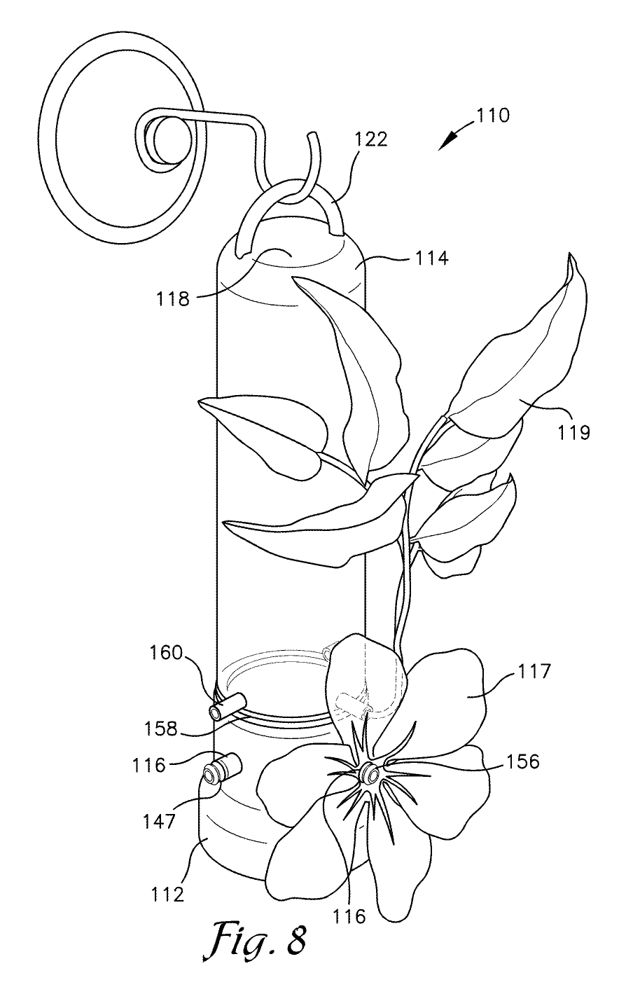

Turning to FIGS. 8 through 13, exemplary embodiments of different configurations of bird feeders with detachable decorative and camouflage features in accordance with the present invention will now be described.

Looking first to FIG. 8, a hummingbird feeder with detachable decorative and camouflage features according to a second exemplary embodiment of the present invention is designated generally by the numeral 110. The feeder includes a cylindrical base 112 at its bottom end and an elongated cylindrical housing 114 extending upwardly from the base. The housing 114 is formed as a cylindrical tank configured to hold a quantity of nectar or liquid feed. With the housing tank 114 in place on the base 112, the interior cavity of the tank is in fluid communication with an inner cavity of the base so that the nectar or liquid feed flows into the base. A U-shaped hanger 122 affixed to the top end of the housing 114 allows the bird feeder to be suspended from a hook or other hanging apparatus.

In a manner similar to that previously described with respect to the first exemplary embodiment, a series of feeding posts 116 are arranged around the perimeter of the base 112 so that nectar can flow through the feeding post for consumption by a bird. The outer end of each post includes a V-shaped annular groove 147 configured to receive the center portion of a synthetic flower 117 and an elastic ring 156 to retain the flower in the manner previously described with respect to the first exemplary embodiment. A ring-shaped foliage support 158 is positioned near the base of the housing, the support including a plurality of foliage receptacles 160 configured with serrated barbs on the inner surface to receive the stem of a piece of organic or synthetic foliage 117 in the manner previously described.

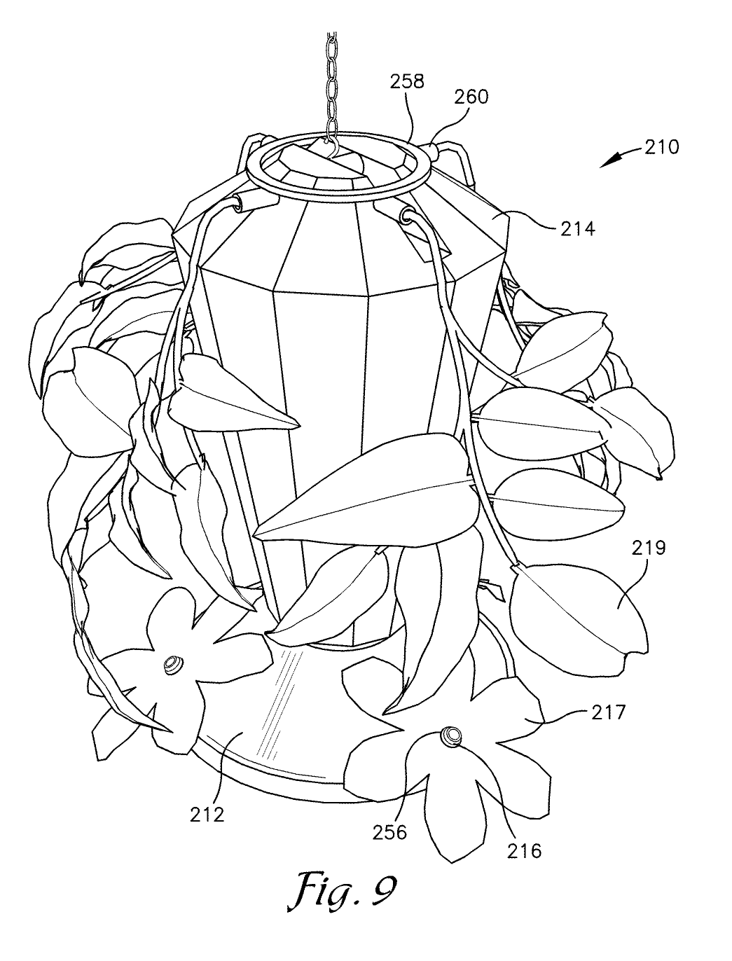

Looking to FIG. 9, a hummingbird feeder with detachable decorative and camouflage features according to a third exemplary embodiment of the present invention is designated generally by the numeral 210. The feeder includes a round base 212 at its bottom end and an elongated diamond-shaped housing tank 214 extending upwardly from and in fluid communication with the base.

A series of feeding posts 216 are arranged around the perimeter of the base 212 so that nectar can flow through the feeding post for consumption by a bird. The outer end of each post includes a V-shaped annular groove configured to receive the center portion of a synthetic flower 217 and an elastic ring 256 to retain the flower in the manner previously described with respect to the first exemplary embodiment. A ring-shaped foliage support 258 is positioned at the top of the housing, the support including a plurality of foliage receptacles 260 configured with serrated barbs on the inner surface to receive the stem of a piece of organic or synthetic foliage 219 in the manner previously described.

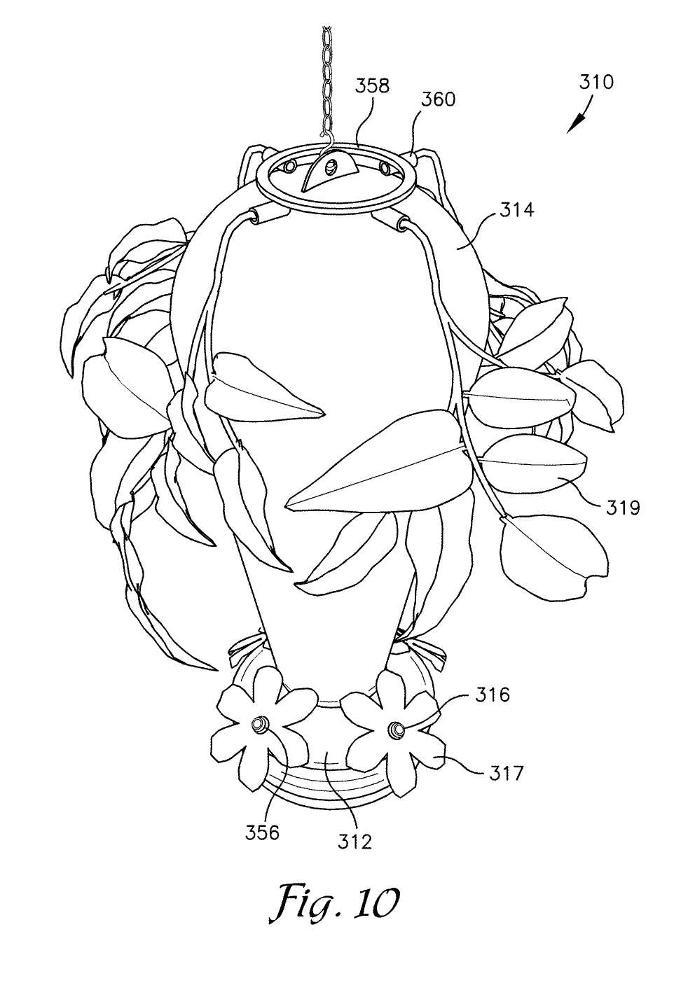

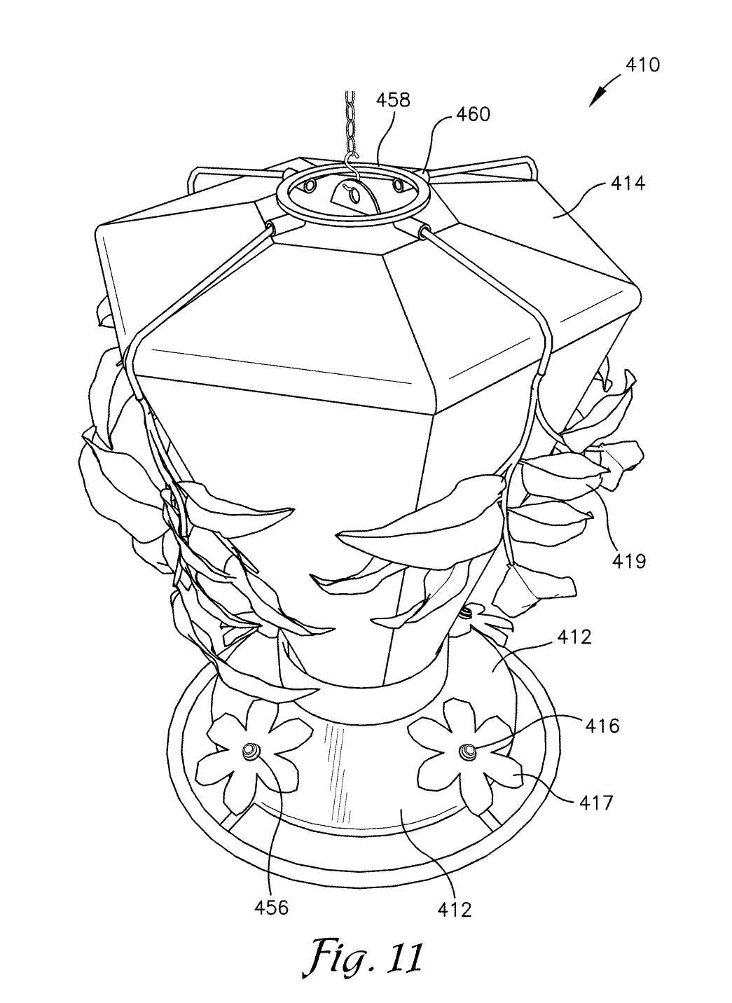

Looking to FIG. 10, a humming bird feeder with detachable decorative and camouflage features according to a fourth exemplary embodiment of the present invention is designated generally by the numeral 310. The feeder includes a small round base 312 at its bottom end and an inverted pear-shaped housing tank 314 extending upwardly from and in fluid communication with the base.

A series of feeding posts 316 are arranged around the perimeter of the base 312 so that nectar can flow through the feeding post for consumption by a bird. The outer end of each post includes a V-shaped annular groove configured to receive the center portion of a synthetic flower 317 and an elastic ring 356 to retain the flower in the manner previously described with respect to the first exemplary embodiment. A ring-shaped foliage support 358 is positioned at the top of the housing, the support including a plurality of foliage receptacles 360 configured with serrated barbs on the inner surface to receive the stem of a piece of organic or synthetic foliage 319 in the manner previously described.

Looking to FIG. 11, a hummingbird feeder with detachable decorative and camouflage features according to a fifth exemplary embodiment of the present invention is designated generally by the numeral 410. The feeder includes a small round base 412 at its bottom end and an elongated, diamond-shaped housing tank 414 extending upwardly from and in fluid communication with the base.

A series of feeding posts 416 are arranged around the perimeter of the base 412 so that nectar can flow through the feeding post for consumption by a bird. The outer end of each post includes a V-shaped annular groove configured to receive the center portion of a synthetic flower 417 and an elastic ring 456 to retain the flower in the manner previously described with respect to the first exemplary embodiment. A ring-shaped foliage support 458 is positioned at the top of the housing, the support including a plurality of foliage receptacles 460 configured with serrated barbs on the inner surface to receive the stem of a piece of organic or synthetic foliage 419 in the manner previously described.

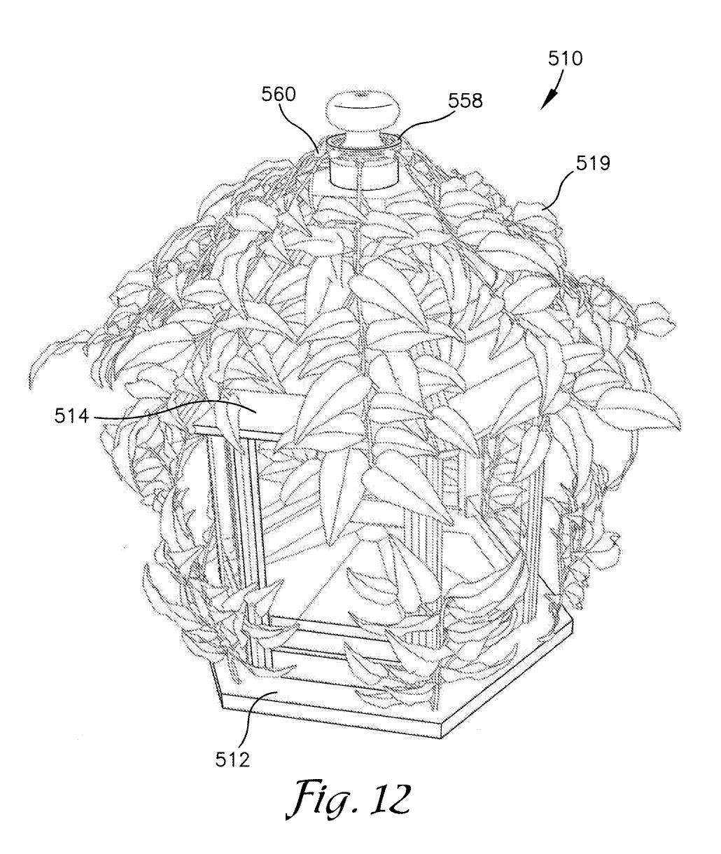

Turning to FIG. 12, a bird feeder with detachable decorative and camouflage features according to a sixth exemplary embodiment of the present invention is designated generally by the numeral 510. The feeder includes a hexagonal shaped base 512 configured to hold a quantity of granular or solid feed. A roof housing 514, supported by a series of posts extending between the base and housing, covers the base and protects the contained granular feed.

A ring-shaped foliage support 558 is positioned at the top of the housing, the support including a plurality of foliage receptacles 560 configured with serrated barbs on the inner surface to receive the stem of a piece of organic or synthetic foliage 519 in the manner previously described.

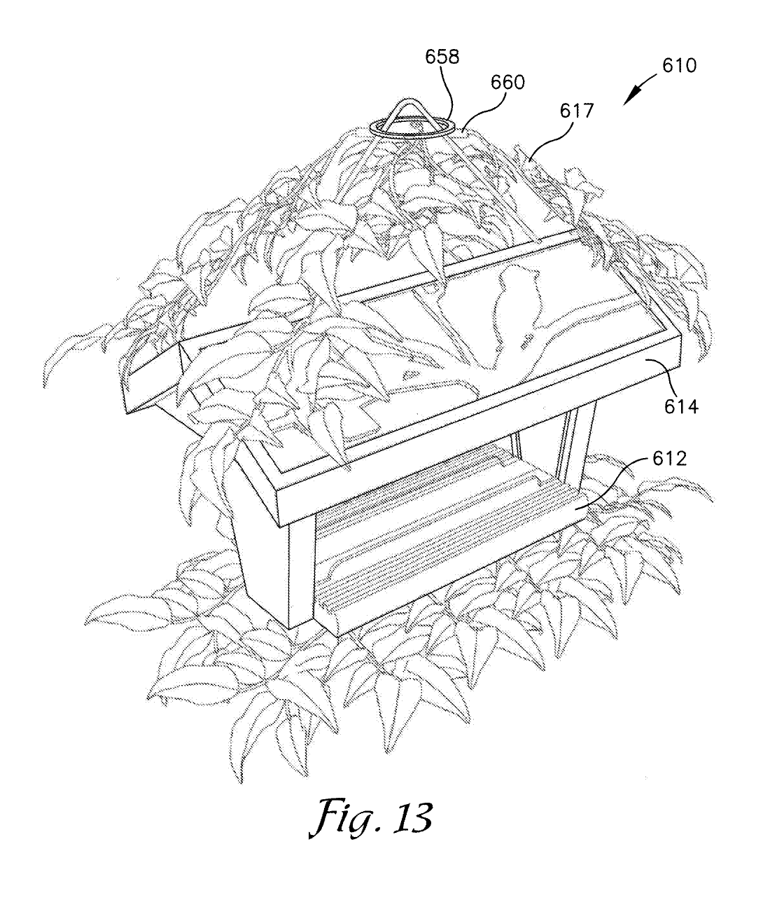

Looking to FIG. 13, a bird feeder with detachable decorative and camouflage features according to a seventh exemplary embodiment of the present invention is designated generally by the numeral 610. The feeder includes a rectangular shaped base 612 configured to hold a quantity of granular or solid feed. A roof housing 614, supported by a two end supports extending between the base and housing, covers the base and protects the contained granular feed.

A ring-shaped foliage support 658 is positioned at the top of the housing, the support including a plurality of foliage receptacles 660 configured with serrated barbs on the inner surface to receive the stem of a piece of organic or synthetic foliage 619 in the manner previously described.

It should be understood that while certain forms and embodiments have been illustrated and described herein, the present invention is not to be limited to the specific forms or arrangement of parts described and shown, and that the various features described may be combined in ways other than those specifically described without departing from the scope of the present invention. The terms “substantially,” “generally,” “approximately,” or any other qualifying term as used herein may be applied to modify any quantitative representation, which could permissibly vary without resulting in a change to the basic function to which it is related. For example, the shape of the foliage receptacles is described as being cylindrical, but may permissibly vary from that configuration if the variance does not materially alter the capability of the invention.

It is to be understood that while certain forms of this invention have been illustrated and described, it is not limited thereto, except in so far as such limitations are included in the following claims and allowable equivalents thereof.

Having thus described the invention, what is claimed as new and desired to be secured by Letters Patent is:

1. A bird feeder with detachable decorative and camouflage features, comprising:
a base having a hollow interior;
a housing attached to and in fluid communication with the base, the housing configured to contain a quantity of liquid bird feed; and
at least one elongated feeding post extending between first and second ends in fluid communication with the base, the feeding post comprising an annular groove configured to receive a detachable decorative feature and an elastic ring to retain the feature on the post.

2. The bird feeder of claim 1, wherein the elongated feeding post is tubular in shape and comprises an interior passageway for conveying liquid feed.

3. The bird feeder of claim 2, wherein the elongated feeding post comprises a threaded first end for attaching the post to the base and wherein the annular groove is positioned proximate the second end of the post.

4. The bird feeder of claim 1, wherein the elastic ring is attached to the detachable decorative feature.

5. The bird feeder of claim 1, further comprising a foliage support configured to detachably retain synthetic or organic foliage, wherein the foliage support comprises at least one foliage receptacle.

6. The bird feeder of claim 5, wherein the foliage receptacle comprises an inner and an outer surface, wherein the inner surface comprises a plurality of serrated barbs.

7. The bird feeder of claim 6, wherein the foliage support is mounted on the housing.

8. A bird feeder with detachable decorative and camouflage features, comprising:
a base configured to contain a quantity of bird feed;
a housing attached to and extending above the base; and
a foliage support positioned proximate said base or said housing, wherein the foliage support comprises at least one foliage receptacle configured to detachably retain a branch or stem of synthetic or organic foliage.

9. The bird feeder of claim 8, wherein the foliage receptacle comprises an inner and an outer surface, wherein the inner surface comprises a plurality of serrated barbs.

10. The bird feeder of claim 9, further comprising a plurality of said foliage receptacles arranged in a radial pattern.

11. The bird feeder of claim 10, wherein the foliage support is mounted on the housing.

12. A bird feeder with detachable decorative and camouflage features, comprising:
a housing configured to contain a quantity of bird feed; and
a foliage support positioned proximate said housing, wherein the foliage support comprises at least one foliage receptacle configured to detachably retain a branch or stem of synthetic or organic foliage, said foliage receptacle having an inner and an outer surface, wherein the inner surface comprises a plurality of serrated barbs.

13. The bird feeder of claim 12, further comprising at least one elongated feeding post extending between first and second ends, the feeding post having an annular groove configured to receive a detachable decorative feature and an elastic ring to retain the feature on the post.

14. The bird feeder of claim 13, wherein the elongated feeding post comprises a threaded first end for attaching the post and wherein the annular groove is positioned proximate the second end of the post.

15. The bird feeder of claim 14, wherein the elastic ring is attached to the detachable decorative feature.

16. The bird feeder of claim 15, wherein the annular groove is V-shaped.
